(19) United States
(12) Patent Application Publication
(10) Pub. No.: US 2008/0147621 A1
(43) Pub. Date: Jun. 19, 2008

(54) Method and system for backup and restoration of content within a blog

(76) Inventor: Aaron Charles Newman, Pittsford, NY (US)

Correspondence Address: Peter S. Canelias;Suite 2148, Law Offices of Peter S. Canelias, 420 Lexington Avenue, New York, NY, 10170, US

(21) Appl. No.: 11/975,015

(22) Filed: Oct. 17, 2007

Related U.S. Application Data
(60) Provisional application No. 60/852,580, filed on Oct. 18, 2006.

(51) Int. Cl. G06F 17/30; G06F 12/00

(52) U.S. Cl. 707/3; 707/204; 707/E17.01; 707/E17.014

(57) ABSTRACT

The method and system is used to collect a complete backup of blog entries for one or more blogs. This backup is used to ensure recoverability in the case of data loss, corruption, or accidental misuse. Because the backup method and system can be used to recover the blog entries across a variety of platforms and hosting solutions, the content within a blog is transferable. These attributes of the blog backup system and method allow a user the freedom to change blogging platforms without sacrificing content. Another novel aspect of the backup system and method is the ability to consolidate and decentralize many blogs that currently exist with new blogs that are just beginning and old blogs that no longer continue to post entries.

### CROSS REFERENCE TO RELATED APPLICATION

This application claims priority to provisional application for patent No. 60/852,580, filed Oct. 18, 2006, and incorporated herein by reference in its entirety.

### BACKGROUND OF THE INVENTION

The present invention relates generally to a method and system for creating a back up and restoring blog entries in a blog. One object of the invention is to provide a single place for creating a backup of a set of blogs associated with an organization, person, or entity for the purpose of creating a separate off-line copy. Another object of the invention provides for a method and system of restoring into the existing or a separate blog or blogging system. Yet another object is to provide a method and system for analyzing and verifying the integrity of any blog's backup.

A web log or “blog” and its following components are a web publishing system generally providing the capability to create blog entries and then view those blog entries through a web site or feed. A blog entry is a distinct record contained within a blog. The blog entry may include fields such as title, content, date, author, and comments. A blog back up is a separate off-line copy of the blog content created to ensure data is recoverable in case of data loss in the blog. The blog content may contain a wide array of media including, but not limited to, text, image video, and audio files. Indeed, the design of the system makes it possible to support any information encapsulated in a structured document. It is important to distinguish between a blog back up, a copy of an existing blog entry, and a blog archive, which is a section of a blog where older blog entries can be viewed.

The invention may be broken into two components, blog backup and blog restoration. Blog backup refers to the storage of blog entries on non-volatile computer memory, such as hard drives, disk arrays or tape drives. A full backup is the collecting of all entries for a blog including entries that may have been backed up in the past. Incremental backup is a collection of only entries that have not be collected in the previous backups. In general, these backups may be collected and backed up by subscribing to their feeds.

A web feed is a data format used for serving users' frequently updated content. Content distributors syndicate a web feed, thereby allowing users to subscribe to it. Making a collection of web feeds accessible in one spot is known as aggregation. RSS, or Really Simple Syndication, is one of the popular feeds for syndicating the content of a blog. A similar feed is the Atom feed. While there are other ways to capture syndicated content, e.g. via an e-mail subscription model, RSS is preferred.

The second component of the invention, blog restoration, refers to the process of recreating blog entries in a blog from a blog backup. Blog software includes software used to create a blog and add blog entries to the blog. Moveable Type and WordPress are just two examples of blog publishing software. Theses are considered back end solutions because they may require installation on a server and connection to a database. A blog hosting-provider is a third-party provider of blogging software or services. TypePad and Blogger are just two examples of the many third-party blog hosting service providers.

Blogs are software tools used to publish ideas, collaborate on work, interact with people, and communicate. The importance of the data contained in blogs makes it critical that blogs be properly protected from data loss. Just as any other valuable information repository should be properly backed up, blogs should also be backed up. As well, any blog entries backup must be restorable to the current system or a separate system.

The large number of blogging software applications and service providers can cause many data inconsistency and integration problems. Blogging takes many forms including personal blogging and business blogging. People and organizations invest thousands of hours or more into their blogs and the information contained in those blogs has become a gold mine. Backing up a blog is complex for many reasons. A large number of blogs are maintained on free blogging systems that are hosted by third-party providers. In these cases, a blogger has no control over the backup policies and procedures of the blog and therefore has no assurance their blog content is properly backed up. As well, the proliferation of blogging systems and software makes finding a single backup solution challenging. An organization attempting to backup blogs of more than a handful of employees soon discovers that each blogging system is a different and complex beast.

Another problem is data lock-in. General principles of network economics suggest that the value of a network increases with the number of users on it. With blogs, the problem of data lock-in is even more pervasive. Competitors in the blog market often offer services and functionality that make it easier for a blogger to continue posting blog entries. These services are generally offered at no cost to the user in an attempt to maintain their user base. They do not, however, offer much functionality with regards to importing or exporting blog posts.

Blogging is both a communication and marketing tool. Investment in a central, repeatable, and transparent blogging backup system can reduce the cost of blogging dramatically. Many bloggers find that they are unable to extract their content or intellectual property from a hosted blogging system. This ties them into a blogging system and leaves them at the will of the hosting provider. As their blog evolves and the requirements of their blog changes, they lack the flexibility of migrating the blog to a different platform. There is always the option of simply starting over on a new system, but this leaves the existing content unavailable on the new system. This invention provides a method and system to backup data from any blogging system and restore data to a different blogging system, allowing a blogger to move hosting providers or blogging systems without losing current content.

From a larger-scale, blog backup and recovery can be problematic because blogs are distributed both inside and outside an organization across a variety of different blogging systems. The simplest ways to setup a blog is through a third-party blog host such as blogger.com, livejournal.com, or wordpress.com. Unfortunately, when blogs are hosted in disparate and decentralized locations, providing basic backup and recovery becomes problematic without the proper tools. Regulations are in effect requiring many corporations, and other organizations, to maintain blogs as business records. Failure to properly backup blogs could lead to liability and unwanted evidentiary presumptions from the unintentional destruction of documents, or failing to properly back up blog entries.

### BRIEF SUMMARY OF THE INVENTION

In an application environment, generally speaking, this invention seeks to provide a backup and restoration solution for the content of one or more blogs. The invention allows a user to register a blog, which may be backed up, by including information such as the location of the blog indicated by a URL. Upon registration of a blog, the system creates an initial backup of blog entries providing a starting point for future backups. On a periodic basis, the invention may update an archive backup with the entries that have been created since the previous full or incremental backup. After the creation of a blog back up, a user may restore blog entries to the original blog, a new hosted blogging system, or on a new blog with a different blog service provider.

This invention creates the capability to backup and restore systems in disparate and decentralized location and bring all that data into a centralized location that can be managed practically. Using the invention, thousands of blogs housed in hundreds of different sources or provider can be backed up providing a large cost savings over requiring each individual blogger to backup their system. The invention may be programmed to backup a blog independent of hosting provider, platform, software, or location; perform ongoing, automated, and scheduled incremental backups; perform restores in the event of catastrophic data loss or accidental deletion; track blog backups and report problems; restore to blogs that may exist on different platforms or software hosted by different providers at different locations.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is a network diagram of the invention in a distributed back up engine embodiment;

FIG. 2 is flow chart outlining the process of creating a back up;

FIG. 3 is a flow chart outlining the process of restoring a blog entry.

### DETAILED DESCRIPTION

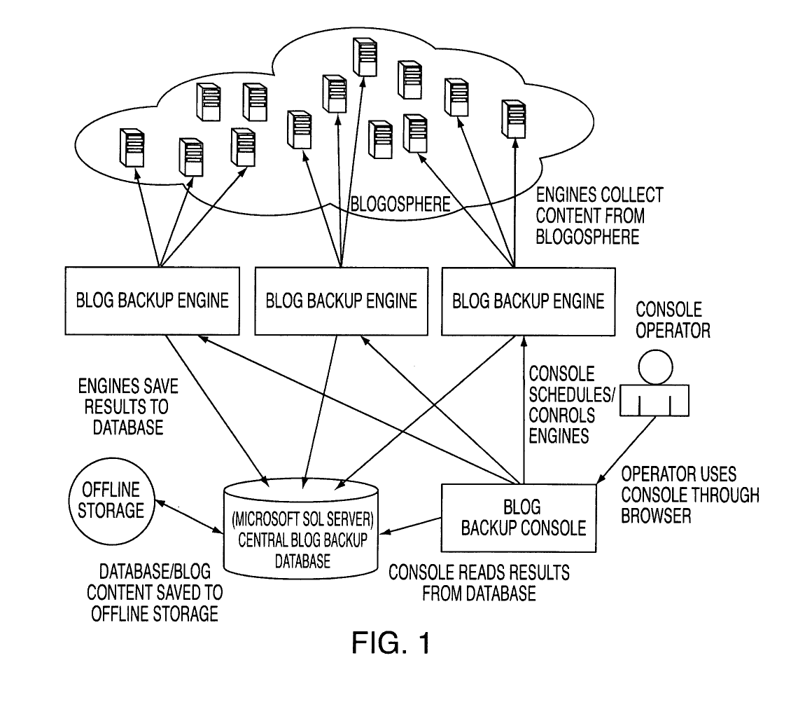

FIG. 1 illustrates a network diagram of the invention in a distributed back up engine embodiment. There are three main layers in FIG. 1, the network/hardware layer, the protocol or connectivity layer, and the software or application layer. Each layer may contain one or more components. For example, the network/hardware layer may include a database, a web server, a web application running on the web server, and a blog backup engine. The possible permutations regarding the components within these layers will be apparent to those skilled in the art.

In FIG. 1, we see the blog backup engines are distributed across a network. These blog back up engines may perform both the back up and restoration of blog posts. To communicate with the various types of blog services, the back up engines may use an Application Programming Interface (API), if one is available. The blog backup engines may also communicate with the various blog services by connecting directly to their database, which may be accomplished by using the username and password of a blogger. In addition, only one blog backup engine is required, while the embodiment in FIG. 1 illustrates a plurality of blog backup engines.

The blog backup engine may function in a number of different ways. The preferred strategy for backing up is an agent-based strategy, which would run a small piece of software on the same server the blog runs on, would backup the blog by connecting locally to the blog using the appropriate database drivers. Another strategy would be to backup remotely from central database backup server. The central server would connect to the blog server using the database protocol to initiate the backup and would use FTP to copy the backed up content to the central backup server. Performing the second backup strategy may require an account with permissions on the blog database to run backup commands and an account on the blog service, providing FTP access to the files.

In FIG. 1, we also see the Blog Backup Console (BBC). The Console is the preferred method for the invention user to communicate with the blog backup engines. In the embodiment the BBC is a web application running on a Windows 2003 Server operating system, with an Intel processor, and a disk array of about 500 GB. The preferred web server application is IIS 6.0 running ASP.NET. The web server is also in communication with a database, preferably Microsoft SQL Server 2005. To be clear, the invention may be installed on almost any operating system, web server application, and hardware combination. The backend is scalable, in that the architecture allows a single instance of the invention to backup and monitor thousands of blogs.

In the preferred embodiment, the storage of blogs occurs on a Microsoft SQL Server database. While there many different interoperable database platforms exist, Microsoft SQL Server is preferred. In addition, storage may be accomplished by providing offline storage capabilities. Offline storage capabilities include physical storage of a backup on DVD or CDROM, or any non-volatile data storage medium, such that the storage medium may be placed in a lockbox or off-site storage.

The preferred embodiment of the BBC consists of a single component, a software component running on a web application server in communication with multiple remote blogs. It is important to note that the web application may also take the form of a plurality of modular web applications running on a set of disparate nodes in a network. The BBC is also preferably embodied as a graphical user interface (GUI) that allows the user to easily control all of the processes necessary for back up and restoration. While a command line may be available for advanced users, the GUI interface is preferred.

To be clear, the BBC may also exist in other forms. For example, the BBC may run as a private web application, operated internally—the private embodiment may require an implementation of the ASP model. As mentioned above, the BBC may also be software or an application a company places on their intranet. For example, a company could place the BBC on their local intranet, providing a consolidated backup of all the company's blogs. In this embodiment, the BBC may consist of multiple web applications running against multiple remote blogs reporting all the data back to a single database. An administrator may access the BBC interface via a web-browser or client application to configure the system and review the results. In this embodiment, the BBC and blog backup engines would process and analyze blogs by running as a service or daemon on the web application.

The BBC may connect to blog services, databases, back up engines, and web servers, either remotely or directly. Although a direct connection (i.e. FTP, Telnet, or SFTP) to the central server, database, and backup engine is possible, it is not required. Preferably, the console operator will access the BBC web application over HTTP via a web browser. On the other hand, the operator may interact with the blog backup engine via a bookmarklet. A bookmarklet is a small JavaScript program that can be stored as a URL within a bookmark in most popular web browsers, or within hyperlinks on a web page. They can modify the way a web page is displayed within the browser (e.g., change the font size, background color, etc.); extract data from a web page (e.g., hyperlinks, images, text, etc.); jump directly to a search engine, with the search term(s) input either from a new dialog box, or from a selection already made on a web page.

When a user decides to backup via a bookmarklet, the user may submit a blog or feed to a validation service. This validation service adds the content resource (text, photos, tags, videos) to the blog backup engine. For example, a user surfing the web and notices a blog the want to start backing up, or they see a file they want to backup, or a video, they just click the bookmarklet and it starts backing up the selected data. This type of backup may also apply to social software websites such as del.icio.us for tags and bookmarks; flickr for images; and youtube.com for video.

Despite which embodiment it takes, the BBC provides the console operator with many capabilities and features to facilitate blog backup and restoration. In the preferred embodiment, the console operator will use the BBC to register, backup, control, update, schedule, analyze, verify, and restore the blog backups. In addition, a user may consolidate one or more blogs, managing them all in a central location.

With more than one blog registered, the user may create an initial and complete backup of all blog entries. In addition, the user may selectively choose which blogs to backup. Through the BBC, the console operator can manually control the frequency of backups or may schedule recurring and periodic incremental backups. The schedule may allow the console operator to retrieve and backup even the most recent of blog entries.

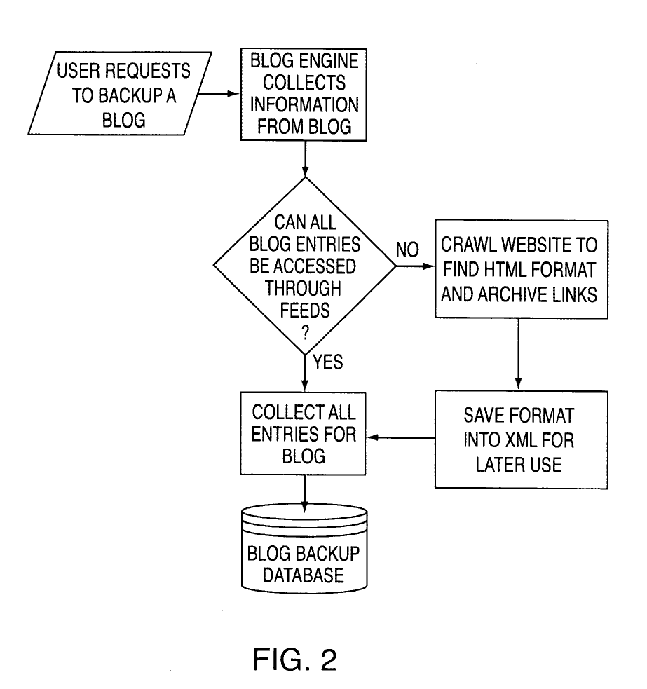

Turning to FIG. 2, we see a flow chart outlining the general process of creating a backup. Before the initial backup is taken, the blog software must determine how it will collect blog entries. The method used is determined based on a number of factors such as the blogging software, the presentation format of the blog, and the feeds available from the blog. Using these factors, the invention will determine the most effective method of collecting blog entries and save that method and its parameters, creating a preferred format. When blog entries are to be collected, the preferred format is loaded and used to collect the blog entries.

The invention will preferably use RSS and Atom feeds to download content from a blog. Most blogging services today will require parsing of HTML to go back through and collect the archived entries, simply because blogging services generally do not re-syndicate old entries through an RSS or Atom feed.

There may be several methods used to collect entries from a blog given different scenarios. For instance, collecting blog information from the RSS feed may be the preferred method of collecting incremental backups, but may not work for collecting archived blog entries since those entries are not typically served through feeds. In that case, an HTML template must be applied to collect entries from the HTML pages of the blog.

The BBC and blog backup engine may operate with any blog platform. The preferred formats are based on templates that define how to read and parse a blog. As blogs change or new blog software is developed and comes to market, or as the formats of existing blogs change, the parsing component and templates can be updated to function properly when reading and parsing blogs.

The parsing component works by starting on the first page of the blog. A list of all links on the page is collected. Then based on the blog software, the links which appear to link to the archives are followed one by one. Those linked pages are loaded and analyzed for blog entries and links to other archived blog pages. When a link that may contain blogs entries is discovered it is put in two lists. The first list is the pages left to search. The second list is the pages already searched. When a new link is discovered, it is not placed into the first list if it is already in the second list, so that the invention does not end up in an endless loop. After a page is loaded and analyzed it is removed from the first list. The iteration ends when the first list is empty.

The BBC and blog backup engines can save more than simply the text of a blog entry. Initially, the data may be stored in standard format in a relational database (RDBMS). A console operator will have the options to export the data into XML. While XML is preferred, the BBC may be equipped with the functionality to import and export via a wide variety of formats and standards.

The blog backup engines may store metadata, or data about data, for the blogs and their entries including what blogging software is being used, what fields the blog is currently supporting, and what format the blog is laid out in. In addition, the blog backup engines may capture comments, trackbacks, blog rolls, ping backs, and subscription lists.

For users that customize the layout or template of their blogs, the blog backup engine may not be able to accurately identify the different fields or components of each blog entry. In these cases, different methods will need to be employed to map the layout of the blogs to the content to extract or collect from the blog. In order to facility this task, the blogger may create a set of specific classes on the content to enable the invention to recognize fields in the blog entries to create an accurate and complete full backup.

In order for the invention to handle customized blog layouts or templates, the blogger will need to edit the template used to format the blog. Most blogging platforms allow this level of customization. If a blogger is customizing the blog to the extent the invention can not recognize the format, the blog also likely possess the skills to update the template to include the specific classes recognized by the invention.

Within the template, which is composed of HTML, CSS, and blog fields (specific to the blogging platform), the blogger will need to add classes that maps to the classes for which the invention is configured to check. A number of classes are specified to indicate the fields in the blog the invention is extracting. Typically the template is modified by placing an HTML div tag with an attribute called class which is set to a class name such as techrigy_blog_entry_title for the title of the blog entry.

The blog backup engines may also back up different types of data—not just blogs, but tags, social bookmarks, or a set of tagged photos. Because the backup engine preferably uses an RSS feed to download content, anything with an RSS feed, such as a calendar, may be backed up. In addition, images on the website flickr.com or audio files embedded in podcasts may also be captured, particularly if they are incorporated into blog posts.

Once the initial backup is taken, the console operator may continue taking backups on regularly scheduled intervals. Backup systems need to be designed to work without requiring human action. The BBC provides the capability to configure and schedule full and incremental backup. Incremental backups may recur hourly, daily, monthly, or weekly. In addition, the incremental backup may be scheduled to occur at a specific time of the day.

A console operator may also use the invention to review, analyze and verify the blog entries backed up. The blog entries for all registered blogs will be stored in the central database in a single location for any blog entry to be accessed. The console operator may also analyze and verify that all blogs have been properly backed up. The invention provides a reporting means that may be quickly scanned to determine if any blogs have not be backed up at the appropriate time. As well, the invention reports any backups that have failed after starting or were not completed successfully. While it is preferred that the console operator review, analyze and verify the integrity of the backups through the BBC; a console operator may also connect directly to the database and manipulate or view the data with a query or a view.

The BBC may also provide a means for restoring the content of a blog or blogs. The invention may use one of several methods to accomplish restoration. The preferred method uses the API of the blogging software to upload entries. For example, blog restoration may be accomplished by calling the appropriate functions for posting in the Metaweblog API, the Blogger API, or the GData API. Another method for restoration includes inserting blog posts and their content directly in the backend database. In addition, blog posts may be uploaded from a hard drive, DVD or CD ROM via FTP. Importing and exporting of blog posts may be scheduled or manually initiated through the BBC.

Similar to the situation for backing up archives, restoring archives may require a different approach. The preferred method is posting the archived blog post through an API such as Metaweblog, however if no API exists for the blog being restored, upload may be done through an HTML form. An attempt is made to correctly tag the uploaded blog entry with the date and time of the original entry. There are other methods for restoring backups that will be apparent to a person skilled in the art.

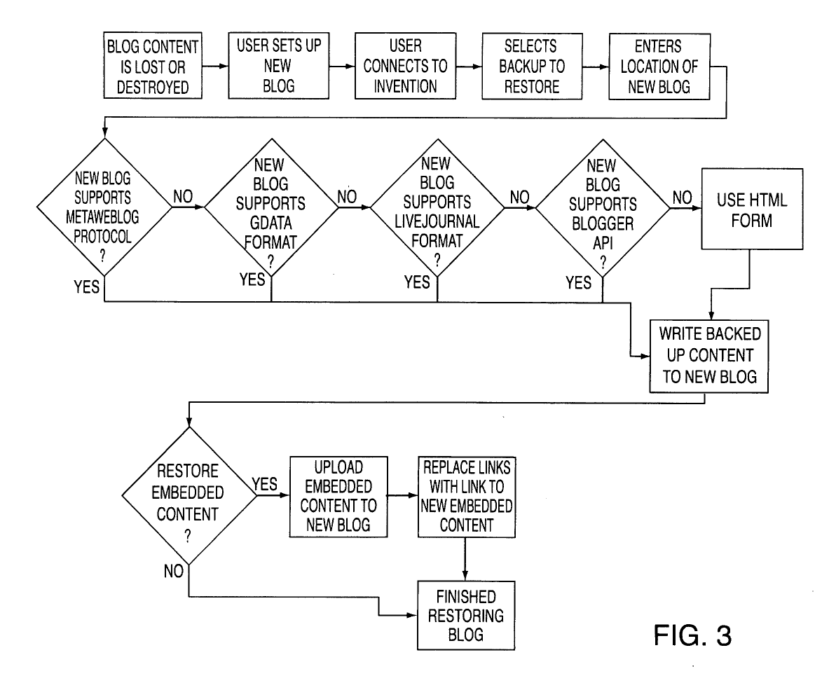

Turning to FIG. 3, we see is a flow chart outlining the process of restoring a blog entry. After a user creates a blog backup account and backs up a blog, the user may require restoration of a blog. To successfully restore blog content, a user may need to establish a restoration site. A restoration site may be a new blog, it may be authorship to a collaborative blog, or it may be any other form that receives structured content. The user then connects to the BBC, or other embodiment. The modes of connecting are similar to those employed when a user initially establishes a backup account mentioned above, see also, FIG. 2. When a user requires a blog backup, establishes a restoration site, and connects to the invention; the restoration process may begin.

Restoration may be accomplished through the GUI of the BBC, or through direct and/or remote connections to the backend databases. Other means for restoration will be apparent to those of skill in the art. The restoration process begins by selecting a backup to restore. A backup may include a single blog post, a selection of blog posts or the entire collection of blog posts. A user restoring blog posts may also select whether to include comments, trackbacks, pingbacks, or any other of many blog attributes. Indeed, the blog posts being restored may have been backed up from one single blog. However, the back up and restoration may also incorporate blog posts from numerous and disparate blogs. When the blog posts are selected the user enters the location of the restoration site, preferably a URL. At this point, the user may also supply access information to the blog hosting service of the restoration site or its backend database, such as a username and password, but this is not required.

When a user gives the blog backup engine all of the appropriate information, the engine administers a set of compliance checks. The compliance checks may include a protocol check, format check, API check, and data transfer check. In the protocol check, the blog backup engine may determine whether the restoration site supports the Metaweblog protocol. To be clear, there exist other protocols and use of metaweblog is merely illustrative. In the format check, the engine may determine whether the restoration use GData, LiveJournal, TypePad, or the XML format. Similarly, there are other formats available; these formats are preferred because of their widespread use. In the API check, the engine determines if the restoration site has an API. Generally, an API gives developers access to code samples giving them a means to accomplish certain functions. In this context, one of the functions would be posting a blog entry to the restoration blog or site. After the compliance checks are complete, a mode for restoring is established and HTML forms may be used to restore the backup.

The blog posts in the blog backup database may now be uploaded to the new restoration blog or site. Uploading may be accomplished via FTP or SFTP. Other data transfer methods are well known in the art. If the old blog contained embedded content, (i.e. images, videos, or audio files), the embedded content is uploaded to the restoration blog's database or to the new blogs operating system file directory. The links of the embedded content in the old blog are then replaced with new links. These new links refer to the new address, preferably a URL under the domain of the restoration site. If a user also backs up syndicated content, such as social bookmarks, syndicated photos or videos, the user may also restore this syndicated content on the restoration site or blog.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A method for collecting and storing a backup of blog entries for one or more blogs comprising steps of:
selecting a first blog;
collecting a set of archived blog entries;
collecting a set of current blog entries;
storing the set of archived and current blog entries in a database;
checking the blog for new blog entries;
collecting a set of new blog entries;
storing the set of new blog entries in the database;
creating a second blog;
uploading the current set of blog entries to the new blog.

2. The method for collecting and storing a backup of blog entries for one or more blogs of claim 1, wherein the step of collecting the set of archived blog entries, further comprises:
identifying at least one hyperlink from a home page on the first blog;
following the hyperlink to a linked page;
identifying a second set of archived blog entries;
storing the identified blog entries in the database;
creating a script for storing the set of archived, current and new blog entries;
storing the script into a directory existing on a blog hosting server.

3. A method for creating a backup of blog entries, comprising steps of:
subscribing to a blog feed;
collecting a first set of blog entries syndicated through the blog feed;
parsing an HTML file, the HTML file being the home page of the blog;
identifying a plurality of attributes in the HTML file that describe a content item of a blog entry;
analyzing the attributes to locate a second set of blog entries;
collecting the second set of blog entries;
storing the first and second set of collected blog entries into a database.

4. The method for creating a backup of blog entries of claim 3, wherein the step of identifying a plurality of attributes in the HTML file that describe a content item in a blog entry further comprises a step of:
parsing a set of hyperlinks, the set of hyperlinks being formatted to identify a section of the html file for accessing archived blog entries.

5. The method for creating a backup of blog entries of claim 3, wherein the step of parsing an HTML file, further comprises a step of:
creating a template for identifying the plurality of attributes in the HTML that describe a content item in a blog entry.

6. The method for creating a backup of blog entries of claim 5, wherein the step of creating a template for identifying the plurality of attributes in the HTML that describe a content item in a blog entry, further comprises steps of:
analyzing the source code of the HTML file;
comparing the content item to a second content item stored in the database, the second content item having a syndication feed that matches the blog feed;
analyzing a set of formats used by a plurality of blog hosts;
parsing an HTML template to determine an appropriate content extraction algorithm;
storing the appropriate content extraction algorithm in the database.

7. The method for creating a backup of blog entries of claim 5, wherein the step of creating a template for identifying the plurality of attributes in the HTML that describe a content item in a blog entry, further comprises steps of:
identifying an extraction template that successfully extracts the content from the blog;
storing the extraction template in the database.

8. The method for creating a backup of blog entries of claim 6, wherein the step of comparing the content item to a second content item stored in the database, the second content item having a syndication feed that matches the blog feed, further comprising steps of:
comparing a blog entry date and a blog title to a set of blog entries stored in the database;
determining whether an extracted blog entry already exists in the database.

9. The method for creating a backup of blog entries of claim 8, further comprising steps of:
hashing a static content item to create a hash value;
storing the hash value for the static content item in the database;
comparing the hash value of the static content item to a hash value for a stored blog entry item.

10. A method for backing up blog entries, comprising steps of:
selecting a first blog;
establishing a connection to a host database;
extracting a first set of blog entries associated with the first blog from the host database;
storing the first set of extracted content items associated with the first blog in a backup database.

11. The method for backing up blog entries of claim 10, further comprising steps of:
selecting a second blog;
establishing a connection to a second host database;
extracting a second set of blog entries associated with the second blog from the second host database;
storing the first and second set of extracted blog entries into a backup database;
consolidating the first and second set of extracted blog entries into a backup database;
restoring the consolidated set of blog entries to a third blog.

12. A method for collecting and storing blog entries for backup purposes comprising steps of:
selecting a plurality of blogs for storing in a blog backup table in a database, the database having a plurality of blog backup tables;
associating a first blog with a first blog backup table in the database;
collecting a set of archived blog entries for the first blog;
collecting a set of current blog entries for the first blog;
storing the set of archived and current blog entries for the first blog in the associated blog backup table;
checking the first blog for new blog entries;
collecting a set of new blog entries for the first blog;
storing the set of new blog entries for the first blog in the associated blog backup table;
creating a new blog for publishing all the entries stored in the first blog backup table;
uploading all of the stored blog entries in the first blog backup table to the new blog.

13. The method for collecting and storing blog entries of claim 12, further comprising steps of:
associating a second blog with at least one blog backup table in a database;
collecting a second set of archived blog entries for the second blog;
collecting a second set of current blog entries for the second blog;
storing the second set of archived and current blog entries for the second blog in the associated blog backup table;
checking the second blog for new blog entries;
collecting a second set of new blog entries for the second blog;
creating a new blog for publishing all the entries stored in first and second blog backup tables;
uploading all of the stored blog entries in the first and second blog backup tables to the new blog.

14. The method for collecting and storing blog entries for backup purposes of claim 12, further comprising steps of:
scheduling a time for collecting the set of new blog entries;
displaying an interface on a digital monitor for reviewing the set of new blog entries that were collected for storage;
permitting a user to restore a selection of blog entries for publishing to the new blog.

15. A method for archiving blog entries from a blog, comprising steps of:
generating a set of metadata tags for a blog entry, the set of metadata tags identifying a plurality of blog entry attributes;
extracting a content item from a first attribute;
associating the content item with at least one metadata tag;
generating an HTML tag based on the at least one metadata tag and the associated content item;
embedding the generated HTML tag within the blog entry;
archiving the blog entry with the embedded HTML tag according to the at least one metadata tag;
storing the archived blog entry in a database.

16. The method for archiving blog entries from a blog of claim 15, wherein the first attribute is a blog title.

17. The method for archiving blog entries from a blog of claim 15, wherein the first attribute is a blog author.

18. The method for archiving blog entries from a blog of claim 15, wherein the first attribute is an entry date.

19. The method for archiving blog entries from a blog of claim 15, wherein the first attribute is an entry title.

20. The method for archiving blog entries from a blog of claim 15, wherein the first attribute comprises at least one of a blog description, an entry permalink, an entry author, an entry body, a comment body, a comment title, a comment author or a comment date.
